(19) United States
(12) Patent Application Publication
(10) Pub. No.: US 2007/0259262 A1
(43) Pub. Date: Nov. 8, 2007

(54) Electrochemical Sensing Method

(76) Inventors: Mark Hyland, Yarnton (GB); John Morton Broughall, Yarnton (GB); Ronald Neil Butler, Yarnton (GB)

Correspondence Address: QUARLES & BRADY LLP, 411 E. WISCONSIN AVENUE, SUITE 2040, MILWAUKEE, WI, 53202-4497, US

(21) Appl. No.: 11/630,739

(22) PCT Filed: Jun. 29, 2005
(86) PCT No.: PCT/GB05/02558

§ 371 Date: Dec. 21, 2006

(30) Foreign Application Priority Data
Jun. 29, 2004 (GB) 0414550.4

(51) Int. Cl. H01M 2/26

(52) U.S. Cl. 429/161; 29/623.1

(57) ABSTRACT

A method of confining an electroactive substance within an electrochemical cell in the form of a receptacle, said method that includes (a) providing an electrochemical cell in the form of a receptacle, the receptacle having a first open part to allow entry of a sample into the receptacle, and a second open part to allow escape of air displaced by the entering sample, the electrochemical cell having a working electrode and a counter electrode; (b) providing an electroactive substance, which substance is contained within the receptacle; (c) providing a permeable or semi-permeable membrane, including one or more layers, covering the first open part of the receptacle; and (d) inserting the sample into the receptacle through the membrane, such that (1) the electroactive substance and (2) the sample, are in contact with each other and with said working electrode; wherein the electroactive substance is confined within the receptacle during step (d). Preferably, the method additionally involves electrochemically testing a sample, by applying a voltage across the cell and measuring the resulting electrochemical response.

### FIELD OF THE INVENTION

The present invention relates to electrochemical methods, in particular, to electrochemical methods involving the use of enzymes or other electroactive substances. The invention also relates to electrochemical devices for use in such methods.

### BACKGROUND TO THE INVENTION

Electrochemical measurements can be carried out by reacting a sample with an enzyme or other electroactive substance, and subsequently electrochemically determining the amount of unreacted electroactive substance present. Such a measurement gives an indication of the extent to which the sample has reacted with the electroactive substance and therefore the nature of the sample itself.

The accuracy of such titrimetric measurement techniques depends on a precise knowledge of the amount of electroactive substance present prior to reaction with the sample. If the amount of pre-reaction electroactive substance is not known precisely, it is not possible to accurately determine the amount of electroactive substance which has reacted with the sample. In a typical procedure, therefore, a known quantity of electroactive substance is placed in the electrochemical cell. The sample to be tested is then contacted with the electroactive substance and reaction allowed to proceed. A potential is then applied across the cell and the amount of unreacted electroactive substance is measured electrochemically.

Electrochemical devices have recently been developed for use, for example, in the medical field. These devices include a test strip on which one or more electrochemical cells are placed. The sample to be tested, such as blood or plasma, is placed onto, or flowed across, the test strip, reacting with an electroactive substance in the electrochemical cell(s) on the strip in order to provide a measurement. However, the exact volume of the blood or plasma which contacts the cell is typically not known. Therefore, when the electroactive substance in the cell is taken up in the test sample, the resulting concentration of the electroactive substance in that sample is not known and cannot easily be determined. Further, the electroactive substance is able to diffuse through the sample and away from the electrochemical cell, causing a gradual reduction in the concentration of electroactive substance in the region of the working electrode. The precise amount of the electroactive substance available for reaction/electrochemical detection can therefore no longer be accurately determined.

A new technique is therefore required which enables more accurate electrochemical measurements of this type to be made.

### SUMMARY OF THE INVENTION

The present inventors have developed a method of carrying out electrochemical reactions in which the enzyme or other electroactive substance is confined within a fixed volume in the vicinity of the electrochemical cell. The method of the invention enables a sample to be directly introduced into the vicinity of the cell, but restricts movement of the electroactive substance out this area. Thus, the method of the present invention enables an accurate determination to be made of the quantity of electroactive substance present during reaction and electrochemical measurement, and correspondingly increases the accuracy of the final determination regarding the sample content.

Thus, the present invention provides a method of confining an electroactive substance within an electrochemical cell in the form of a receptacle, said method comprising
(a) providing an electrochemical cell in the form of a receptacle, the receptacle having a first open part to allow entry of a sample into the receptacle, and a second open part to allow escape of air displaced by the entering sample, the electrochemical cell having a working electrode and a counter electrode;
(b) providing an electroactive substance, which substance is contained within the receptacle;
(c) providing a permeable or semi-permeable membrane, comprising one or more layers, covering the first open part of the receptacle; and
(d) inserting the sample into the receptacle through the membrane, such that (1) the electroactive substance and (2) the sample, are in contact with each other and with said working electrode;
   wherein the electroactive substance is confined within the receptacle during step (d).

The use of a membrane covering the open part of the receptacle essentially fixes, or limits, the volume of sample which is available to react with the electroactive substance. Further, the membrane reduces the tendency of the electroactive substance to diffuse out of the receptacle once taken up by the sample. The membrane typically confines the electroactive substance within the volume defined by the receptacle and the membrane for a sufficient period of time to enable reaction with the sample, and electrochemical measurement, to take place. Therefore, the presence of the membrane enables the amount of electroactive substance available for reaction with the sample to be more precisely determined.

The present invention also provides the use of a membrane comprising one or more layers to confine an electroactive substance within a receptacle following insertion into the receptacle of a liquid sample,
wherein the receptacle comprises a first open part, and is in the form of an electrochemical cell,
wherein the membrane is permeable to the smnple, and is located such that it covers the first open part of the receptacle, and
wherein the electroactive substance is contained within the receptacle prior to insertion of the sample.

The present invention also provides a device comprising
an electrochemical cell in the form of a receptacle, the receptacle having a first open part to allow entry of a sample into the receptacle, and a second open part to allow escape of air displaced by the entering sample, wherein the electrochemical cell has a working electrode and a counter electrode;
an electroactive substance contained in the receptacle;
a permeable or semi-permeable membrane, comprising one or more layers, positioned such that it covers the first open part of the receptacle;
means for applying a voltage across the cell; and
means for measuring the resulting electrochemical response across the cell.

### BRIEF DESCRIPTION OF THE FIGURES

FIG. 1 depicts a device according to one embodiment of the invention;

FIG. 2 depicts a device according to an alternative embodiment of the invention;

FIG. 3 depicts a plot of current (I) versus potential (V) for an electrochemical test to determine the quantity of electrochemically detectable cobalt in a sample, the test being carried out using the method of the invention; and

FIG. 4 depicts a plot of the ratio I(Co)/I(Ru) versus time for an electrochemical test to determine the quantity of electrochemically detectable cobalt in a sample over a time period of up to 4 minutes.

### DETAILED DESCRIPTION OF THE INVENTION

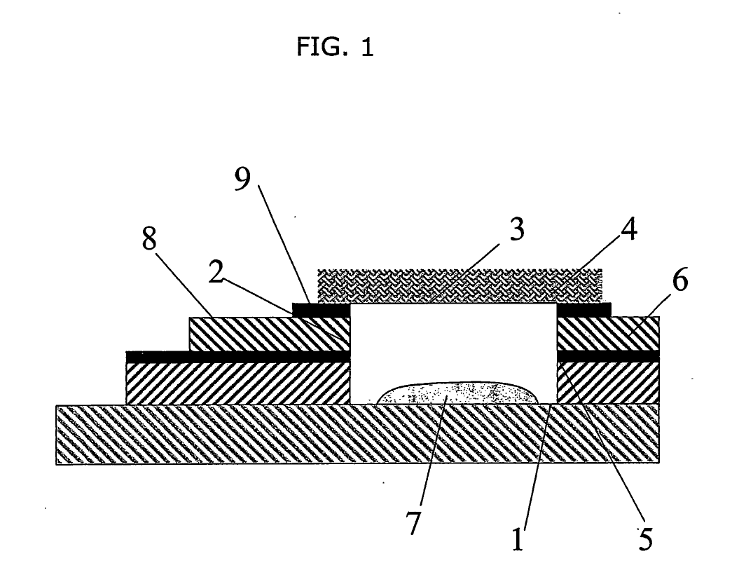

The method of the present invention is carried out using an electrochemical cell in the form of a receptacle or a container. The receptacle may be in any shape as long as it is capable of containing a liquid which is placed into it. For example, the receptacle may be cylindrical. An example of a device comprising an electrochemical cell in the form of a receptacle is depicted in FIG. 1. In this embodiment, the receptacle has a base 1 and a wall or walls 2 which surround the base. The receptacle also has a first open part 3. The open part of the receptacle is an area through which a liquid can enter the receptacle.

Typically, the receptacle will have a depth (i.e. from top to base) of from 25 to 1000 μm. In one embodiment, the depth of the receptacle is from 50 to 500 μm, for example from 100 to 250 μm. In an alternative embodiment, the depth of the receptacle is from 50 to 1000 μm, preferably from 200 to 800 μm, for example from 300 to 600 μm. The length and width (i.e. from wall to wall), or in the case of a cylindrical receptacle the diameter, of the receptacle is typically from 0.1 to 5 mm, for example 0.5 to 2.0 mm, e.g. from 0.5 to 1.5 mm, such as 1 mm.

The electrochemical cell comprises a working electrode 5 and a counter electrode (not depicted). It is preferred that the electrochemical cell has at least one microelectrode. Typically, the working electrode is a microelectrode. For the purposes of this invention, a microelectrode is an electrode having at least one dimension not exceeding 50 μm. The microelectrodes of the invention may have a dimension which is macro in size, i.e. which is greater than 50 μm. In the embodiment depicted in FIG. 1, the working electrode 5 is a microelectrode.

The working electrode is typically in a wall of the receptacle as is depicted in FIG. 1, but may alternatively be, for example, in the base of the receptacle. The working electrode is, for example, in the form of a continuous band around the wall(s) of the receptacle.

The thickness of the working electrode is typically from 0.01 to 25 μm, preferably from 0.05 to 15 μm, for example 0.1 to 20 μm, more preferably from 0.1 to 10 μm. Thicker working electrodes are also envisaged, for example electrodes having a thickness of from 0.1 to 50 μm, preferably from 5 to 20 μm. The thickness of the working electrode is its dimension in a vertical direction when the receptacle is placed on its base. The working electrode is preferably formed from carbon, palladium, gold, platinum, copper or silver, e.g. carbon, palladium, gold or platinum for example in the form of a conductive ink. The conductive ink may be a modified ink containing additional materials, for example platinum and/or graphite and/or an electrocatalyst (e.g. an enzyme) and/or a mediator. Suitable electrocatalysts and mediators are described further below with reference to the electroactive substance. Two or more layers may be used to form the working electrode, the layers being formed of the same or different materials.

The cell also contains a counter electrode which may be present, for example, in the base of the receptacle or in a wall or walls of the receptacle. The counter electrode is typically made from Ag/AgCl, although other materials may also be used. Suitable materials for use as the counter electrode will be known to the skilled person in the art.

The counter electrode typically has a surface area which is of a similar size to, or which is larger than, for example substantially larger than, that of the working electrode 5. Typically, the ratio of the surface area of the counter electrode to that of the working electrode is at least 1:1, for example at least 2:1 or at least 3:1 preferably at least 4:1. The counter electrode may, for example, be a macroelectrode. Preferred counter electrodes have a dimension of 0.01 mm or greater, for example 0.1 mm or greater. This may be, for example, a diameter of 0.1 mm or greater. Typical areas of the counter electrode are from 0.001 mm² to 150 mm², e.g. up to 100 mm², preferably from 0.1 mm² to 60 mm², for example from 1 mm² to 50 mm². The minimum distance between the working electrode and the counter electrode is, for example, from 10 to 1000 μm, for example from 10 to 300 μm or from 400 to 700 μm.

The cell may optionally comprise one or more reference electrodes in addition to the working and counter electrodes. In the case that no reference electrode is present, the counter electrode acts as a reference or pseudo reference electrode. Suitable materials for producing the reference electrode will be known to the skilled person in the art. Ag/AgCl is an example of a suitable material.

Where a Ag/AgCl counter or reference electrode is used, a more stable measurement at this electrode can be obtained when sufficient chloride is present. In one embodiment of the invention, therefore, additional chloride is added to the receptacle, which may improve the measurement at the Ag/AgCl electrode. Typically, the chloride source is present in the receptacle prior to insertion of the sample. For example, the chloride source may be comprised in the electroactive substance.

The chloride source is typically a chloride salt, for example an alkali metal chloride, alkaline earth metal chloride or ammonium chloride. Potassium and sodium chloride are particularly preferred. The chloride salt is typically added in an amount such that when mixed with a sample to be tested, the concentration of chloride salt in the resulting mixture is from 1 to 300 mmoldm⁻³, preferably from 6 to 60 mmoldm⁻³, more preferably from 10 to 30 mmoldm⁻³. The chloride salt may, however, be added at a lower concentration or be absent entirely, in particular where the sample itself contains chloride salts.

In alternative embodiments of the invention, the counter and/or reference electrode is made of a different metal/salt combination. In this case, the anion which is typically added to the composition corresponds to that used in the counter/reference electrode.

For example, where a Ag/Ag₂SO₄ counter/reference electrode is used, a sulfate salt is typically added to the composition. Suitable sulfate salts include alkali metal and alkaline earth metal sulfates and ammonium sulfate, in particular potassium and sodium sulfate.

The first open part of the receptacle 3 is covered with a permeable or semi-permeable membrane 4. Thus, the receptacle and the membrane (typically together with adhesive 9) define the volume into which sample will be inserted. This volume should usually be known in order that the volume of sample which enters the receptacle is known. Suitable volumes will vary depending on the measurement to be carried out and the size of the electrodes used. Suitable volumes in which microelectrodes are employed are in the region of from 0.1 μl to 25 μl.

The membrane is permeable, at least, to the sample to be tested. For the purposes of the present invention, the sample is the material which contacts the working electrode. In one embodiment, a specimen comprising the sample is supplied to the device of the invention. A filter, for example a filtration membrane, is positioned in the device such that the specimen is filtered prior to contacting the working electrode. For example, the specimen may be whole blood and a blood filtration membrane may be present which, for example, allows only plasma to pass through. In this case, the sample is plasma.

The required permeability of the membrane may be, for example, due to the presence of holes in the membrane material, or it may be due to the permeability of the membrane material itself. It is preferred that the membrane material itself is permeable to the sample. The membrane also preferably has a low protein binding capacity.

The membrane material to be used will be selected depending on the nature of the sample to be tested. The skilled person would be able to select a suitable material which is permeable to the sample to be tested based on the knowledge of available membrane materials. However, suitable materials for use as the membrane include polyester, cellulose nitrate, polycarbonate, polysulfone, microporous polyethersulfone films, PET, cotton and nylon woven fabrics, coated glass fibres and polyacrylonitrile fabrics.

These fabrics may optionally undergo a hydrophilic or hydrophobic treatment prior to use. Other surface characteristics of the membrane may also be altered if desired. For example, treatments to modify the membrane's contact angle in water may be used in order to facilitate flow of the desired sample through the membrane. The membrane may comprise one, two or more layers of material, each of which may be the same or different, e.g. a composite of two or more membranes. For example, conventional double layer membranes comprising two layers of different membrane materials may be used.

The membrane may also be used to filter out some components which are not desired to enter the cell. For example, some blood products such as red blood cells or erythrocytes may be separated out in this manner such that these particles do not enter the cell. Suitable filtration membranes, including blood filtration membranes, are known in the art. Examples of blood filtration membranes are Presence 200 of Pall filtration, Whatman VF2, Whatman Cyclopore, Spectral NX and Spectral X. Fibreglass filters, for example Whatman VF2, can separate plasma from whole blood and are suitable for use where a whole blood specimen is supplied to the device and the sample to be tested is plasma.

A spreading membrane may be used as an alternative to, or typically in addition to, a filtration membrane. Thus, for example, the membrane may be a composite of a spreading membrane and a filtration membrane, with the spreading membrane typically the outer membrane which will contact the specimen first. Appropriate spreading membranes are well known in the art and Petex is an example.

The membrane preferably has a pore size of from 0.8 to 5 ml, e.g. up to 3 μm. Where the pore size is greater than about 5 μm, the electroactive substance may be confined in the receptacle only for a very short period. However, if the pore size is less than about 0.8 μm, the sample may not easily be able to enter the receptacle. The pore size of the membrane is typically wider on the surface exposed to the outside of the receptacle than the surface exposed to the inside of the receptacle. In this case, the pore size of the surface exposed to the inside of the receptacle is typically in the range 0.8 to 5 μm, e.g. up to 3 μm.

The membrane is typically attached to the receptacle using an adhesive, for example a double sided adhesive. An example of a suitable adhesive is Arcare 7841 from Adhesives Research In the embodiment depicted in FIG. 1, an adhesive 9 is used to fix the membrane 4 to the top surface of the receptacle walls 8. Thus, the volume of the receptacle is defined by the receptacle base 1 and walls 2 as well as the adhesive 9 and membrane 4. Varying the thickness of the adhesive is therefore a useful technique for controlling the total volume of the receptacle. The counter and working electrodes are preferably both exposed to a sample contained within this volume.

The adhesive 9 typically has a thickness of at least 50 μm and preferably no more than 200 μm, for example no more than 150 μm or 120 μm. When plasma is used as the sample, if the adhesive is too thick, for example greater than about 200 μm, a sheen of plasma slowly builds up on the underside of the membrane before being drawn into the well. The time to fill the well with plasma is therefore increased and can be as long as 5 to 10 minutes. Preferred thicknesses of the adhesive vary depending on the membrane used. Preferred adhesive thicknesses for a Whatman VF2 membrane are from 50 to 150 μm.

In order that the cell can operate, the electrodes must each be separated by an insulating material 6. The insulating material is typically a polymer, for example, an acrylate, polyurethane, PET, polyolefin, polyester, PVC or any other stable insulating material. In one embodiment, the insulating material is an acrylate, polyurethane, PET, polyolefin or polyester. Polycarbonate and other plastics and ceramics are also suitable insulating materials. The insulating layer may be formed by solvent evaporation from a polymer solution. Liquids which harden after application may also be used, for example varnishes. Alternatively, cross-linkable polymer solutions may be used which are, for example, cross-linked by exposure to heat or UV or by mixing together the active parts of a two-component cross-liable system. Dielectric inks may also be used to form insulating layers where appropriate. In an alternative embodiment, an insulating layer is laminated, for example thermally laminated, to the device.

The electrodes of the electrochemical cell may be connected to any required measuring instruments by any suitable means. Typically, the electrodes will be connected to electrically conducting tracks which are themselves connected to the required measuring instruments.

The electroactive substance 7 is contained in the receptacle. A known amount of electroactive substance is generally used. Typically, the electroactive substance is in dried form. The electroactive substance may be any substance which is capable of generating a current when a potential is applied to the cell. Typically, the electroactive substance is capable of reacting with a component which may be present in the sample. The unreacted electroactive substance can then be detected by electrochemical reaction. An example of a suitable electroactive substance is a composition comprising a transition metal salt.

The electroactive substance 7 may comprise an electrocatalyst and a mediator. A mediator is a chemical species that has two or more oxidation states of distinct electroactive potentials that allow a reversible mechanism of transferring electrons/charge to an electrode. The mediator reacts with the sample in the electrochemical reaction, the reaction being catalysed by the electrocatalyst. Typical examples of an electrocatalyst are enzymes, for example lactate oxidase, cholesterol dehydrogenase, lactate dehydrogenase, glycerol kinase, glycerol-III-phosphate oxidase and cholesterol oxidase. Ionic species and metal ions, for example cobalt, may also be used as the electrocatalyst. Examples of suitable mediators are ferricyanide/ferrocyamide and ruthenium compounds such as ruthenium (I) hexamine salts (e.g. the chloride salt).

The electroactive substance may also comprise a buffer which maintains the pH of the electroactive substance at the optimum level for the particular sample being tested. Buffers which can be used include sodium phosphate, Goods buffer, tris(hydroxymethyl)aminomethane (Tris), citrate/phosphate, 3-morpholinopropanesulfonic acid (MOPS), 2-morpholinoethanesulfonic acid (MES), N-2-hydroxyethyl piperazine (HEPES), tricine, bicine, piperazine-N,N′-bis(2-ethane sulfonic acid) (PIPES), N-tris(hydroxymethyl)methyl-2-aminoethane sulfonic acid (TES), 3-(cyclohexylamino)-1-propanesulfonic acid (CAPS) and [(2-hydroxy-1,1-bis[hydroxymethyl]ethyl)amino]-1-propanesulfonic acid (TAPS) as well as other biological buffers. Preferred buffers are those which do not interfere with the electrochemical reactions to be carried out.

The receptacle also comprises at least one second open part. The second open part or parts allow escape of air displaced through entry of the sample liquid into the receptacle. This facilitates entry of the sample into the receptacle, and assists in filling the receptacle completely with the sample. If the receptacle is not completely filled, the volume of sample present in the receptacle cannot be accurately determined.

The second open part typically takes the form of small air-holes in the base or wall(s) of the receptacle (not depicted in FIG. 1). Typically, one or more, e.g. from 1 to 4 air holes may be present. The second open part or parts typically have capillary dimensions, for example, they may have an approximate diameter of 1-600 μm, for example from 100 to 500 μm. Thus, the second open part(s) are typically of sufficiently small size that the sample inserted into the receptacle will not flow out of the receptacle through the second open part(s) due to surface tension.

In one embodiment of the invention, the base of receptacle is in the form of a porous hydrophobic or hydrophilic membrane. In this embodiment, the second open part is formed by the plurality of holes in the membrane. Appropriate porous membranes are known in the art, and Versapor™ by Pall is an example.

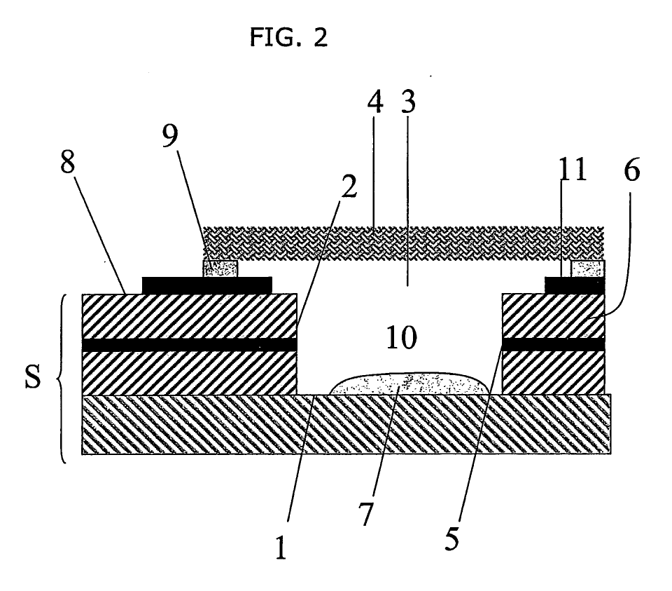

An alternative device according to the invention is depicted in FIG. 2. The device of this embodiment is the same as the device depicted in FIG. 1 and described above, except as set out below. In this embodiment, the device comprises a strip S. The strip S may have any shape and size, but typically has a first surface 8 which is substantially flat. The strip comprises a receptacle 10 bounded by base 1 and wall or walls 2. The device further comprises an electrochemical cell having a working electrode 5 in the wall(s) of the receptacle. The working electrode is typically a microelectrode.

The device of this embodiment comprises an electrode 11 which is a counter or reference electrode or a pseudo reference electrode acting as both reference and counter electrodes. The electrode 11 is hereinafter referred to as the pseudo reference electrode. The pseudo reference electrode comprises a pseudo reference electrode layer 11 present on the first surface of the strip 8. The first surface of the strip is an external surface, i.e. it is a surface exposed to the outside of the device rather than a surface exposed to the interior of the receptacle. Typically, the pseudo reference electrode layer substantially surrounds the receptacle or partial receptacle 10. As depicted in FIG. 2, it is preferred that the pseudo reference electrode layer is not in contact with the perimeter of the first open part 3. Typically, the pseudo reference electrode layer is at a distance of at least 0.1 mm, preferably at least 0.2 mm from the perimeter of the first open part. At least a part of the pseudo reference electrode is, however, typically no more than 2 mm, for example no more than 1 mm or 0.5 mm, preferably no more than 0.4 mm from the perimeter of the first open part. In one embodiment, the pseudo reference electrode substantially surrounds the receptacle or partial receptacle at a distance of from 0.01 to 11.0 mm, for example from 0.1 to 0.5 mm, or 0.2 to 0.4 mm from the perimeter of the first open part. Alternatively, this distance may be from 0.01 to 0.3 mm or from 0.4 to 0.7 mm.

The thickness of the pseudo reference electrode is typically similar to or greater than the thickness of the working electrode. Suitable minimum thicknesses are 0.1 μm, for example 0.5, 1, 5 or 10 μm. Suitable maximum thicknesses are 50 μm, for example 20 or 15 μm.

The pseudo reference electrode 11 typically has a surface area which is of a similar size to, or which is larger than, for example substantially larger than, that of the working electrode 5. Typically, the ratio of the surface area of the pseudo reference electrode to that of the working electrode is at least 1:1, for example at least 2:1 or at least 3:1 preferably at least 4:1. The pseudo reference electrode may, for example, be a macroelectrode. Where the ratio of the surface area of the pseudo reference electrode to that of the working electrode is greater than 1:1, this helps to ensure that the electrochemical reaction occurring at the pseudo reference electrode is not current-limiting. The actual area of the pseudo reference electrode is, for example, from 0.001 mm² to 150 mm², e.g. up to 100 mm² or from 0.1 mm² to 60 mm², for example from 1 mm² to 50 mm².

A membrane 4 is attached to the device by any suitable attachment means 9, for example using a double-sided adhesive tape. Typically, the attachment means attaches the membrane to the first surface of the strip or to the pseudo reference electrode layer. In a preferred embodiment as depicted in FIG. 2, the membrane is attached to the pseudo reference electrode layer 11 at a location which is remote from the perimeter of the receptacle itself. Further, the attachment means is at a greater distance from the first open part of the receptacle 3 than the pseudo reference electrode layer, such that at least a part of the surface of the pseudo reference electrode layer close to or surrounding the receptacle is exposed to a sample which has passed through the membrane. Preferably, the attachment means is at least 0.2 mm, for example at least 0.3 mm or at least 0.4 mm, from the perimeter of the receptacle.

In the embodiment depicted in FIG. 2, a reaction volume is defined by the receptacle base 1 and walls 2, part of the surface of the strip 8, the pseudo reference electrode layer 11, the attachment means 9 and the membrane 4. This reaction volume can be varied by changing the volume of the receptacle, the position and thickness of the pseudo reference electrode layer and the position and thickness of the attachment means 9. Preferred reaction volumes are at least 0.05 μl, for example at least 0.1 or at least 0.2 μl. It is further preferred that the reaction volume is no more than 25 μl, preferably no more than 5 μl, for example no more than 3 μl or no more than 2 μl.

Further details regarding electrochemical cells which can be used in the devices of the present invention can be found in WO 03/05319, GB application no. 0414546.2 and the international application claiming priority therefrom (entitled ELECTRODE FOR ELECTROCHEMICAL SENSOR and filed on the same day as the present application). The contents of these applications are incorporated herein by reference in their entirety.

The method of the present invention comprises inserting a liquid sample into the receptacle through the membrane. Flow of the sample into the receptacle may be aided by the presence of one or more second open parts to allow escape of displaced air. On entry of the sample into the receptacle, contact occurs between the electroactive substance and the sample in such a manner that reaction can take place. The mixture of sample and electroactive substance contacts the working electrode. Contact also typically occurs between the counter/reference electrode(s) and the sample. The sample which contacts these electrodes is optionally mixed with the electroactive substance.

The sample may be any material on which electrochemical testing is to be carried out. The sample is in liquid form, such as a suspension or solution. Examples of materials which can be used as the sample in the present invention include water or aqueous solutions or suspensions, such as river water, and biological samples, for example blood, plasma, serum or urine. Preferred examples of the samples to be tested include plasma and serum.

The sample is inserted into the receptacle through the membrane. Typically, the sample enters by capillary flow through the membrane, although other methods, for example diffusion, can be envisaged.

Typically, the electroactive substance is in dried form and, on insertion of the sample into the receptacle, the electroactive substance is suspended in the sample liquid. In order to aid this re-suspension step, a wetting agent may be present. Typically, any wetting agent is placed into the receptacle prior to insertion of the sample. For example, the wetting agent may be comprised in the electroactive substance.

The presence of the membrane over the first open part of the receptacle effectively fixes the volume of sample that enters the receptacle. Thus, the concentration of the electroactive substance in a suspension of the sample can be determined. Furthermore, the membrane restricts diffusion of the electroactive substance out of the receptacle. Thus, the membrane confines the electroactive substance within the receptacle for a period of time. In accordance with the present invention “confined in the receptacle” or “confined in the electrochemical cell in the form of a receptacle” means that substantially all of the electrochemical substance initially present in the receptacle remains contained within the receptacle.

In a preferred embodiment of the invention, the method additionally comprises applying a potential across the electrochemical cell and measuring the resulting electrochemical response. Typically, the current is measured. Thus, the method can be used to carry out electrochemical tests on the sample inserted into the receptacle. Typically, a period of time, or incubation time, is allowed to lapse between inserting the sample into the receptacle and applying a potential to the cell. This incubation period enables the electroactive substance to resuspend in the sample, and the sample to react with the electroactive substance. The incubation period is typically in the region of from 1 second to 1 minute, although the skilled person will be able to select a suitable period which may or may not fall within this range, depending on the sample and electroactive substance used.

After applying the potential across the cell, the resulting electrochemical response, typically the current, is measured one or more times, with measurements typically completed within a period of up to about 2 minutes, for example up to about 1 minute, from the time of applying the potential.

Confinement of the electroactive substance within the receptacle is typically effective only for a limited period of time. However, in accordance with the present invention, the electroactive substance is confined within the receptacle at least during insertion of the sample. In a further embodiment, the electroactive substance is confined within the receptacle during insertion of the sample, during the incubation period, and preferably also during measurement of the current generated by the cell. Thus, the electroactive substance is preferably confined within the receptacle for at least 1 minute from insertion of the sample into the receptacle, preferably at least 2 minutes, more preferably at least 5 minutes. Different membranes may provide different confinement periods. For example, a Whatman VF2 membrane provides a confinement period of approximately 140 seconds.

The devices of the invention can be produced by forming a laminate structure comprising a layer of working electrode material (e.g. a layer of graphite) between two layers of insulating material. A hole is then punched through this laminate, thus forming the wall(s) of the receptacle. A base, optionally comprising a counter electrode, is then added. The counter electrode may alternatively be provided by printing a layer of a suitable material onto the surface of the laminate. Where one or more second open parts are desired in the base or wall(s) of the receptacle, these can be formed by any suitable technique, for example by drilling or punching a hole, or by use of a porous membrane as the base.

The electroactive substance is then inserted into the receptacle thus formed by any suitable technique. Typically, the electroactive substance is inserted into the receptacle in such a position that it is not in contact with the working electrode. This ensures that fouling of the working electrode is minimised or avoided. The electroactive substance may be dried to ensure that it remains in position. For example, the electroactive substance is inserted into the receptacle in the form of a solution or suspension and then air-dried. The electroactive substance may alternatively be dried by freeze-drying, vacuum drying or oven drying (heating).

In one embodiment of the invention, the electroactive substance is pre-coated onto the substrate which forms the base of the receptacle. This may be done either by directly coating the electroactive substance onto a flat substrate, or by forming a well in the substrate and dispensing an electroactive substance into the well. Typically, the electroactive substance is then dried into position and the thus-coated substrate is joined to the walls of the receptacle. Where the electroactive substance is inserted into a well in the substrate, the well typically has a cross-section which is identical to that of the final electrochemical cell. Thus, the well creates the bottom part of the receptacle formed by the electrochemical cell. This embodiment has the advantage that the electroactive substance is kept remote from the working electrode at all times during manufacture of the cell. Contact between electroactive substance and working electrode is therefore minimised before the cell is used. This in turn minimises fouling of the working electrode.

Following insertion of the electroactive substance, the membrane is attached to the first open part of the receptacle. This can be achieved by any suitable means, for example by adhering the membrane to the top of the receptacle using double-sided adhesive.

Further details regarding the process for producing cells such as that depicted in FIG. 1 can be obtained from WO 03/056319, GB application no. 0414546.2 and the international application claiming priority therefrom (entitled ELECTRODE FOR ELECTROCHEMICAL SENSOR and filed on the same day as the present application), each of which are referenced above.

In a preferred embodiment, the method of the invention is used in a titrimetric electrochemical test for determining whether a sample of bodily fluid is healthy or ischemic. This test can also be used in the diagnosis of ischemia in a patient, by carrying out the test on a sample of bodily fluid taken from the patient.

In this embodiment, the electroactive substance comprises a transition metal salt which is capable of electrochemically distinguishing between ischemic and healthy samples using the method of the invention. A skilled person would be able to determine whether a transition metal salt is suitable by carrying out the method of the invention on (i) a sample known to be healthy and (ii) a sample known to be ischemic. A suitable transition metal salt will provide a higher current reading for sample (ii) than sample (i). It is thought that the difference in the binding capacity of the transition metal to healthy and ischemically modified proteins (e.g. albumin) in the sample is important in the mechanism of this type of test. Therefore, typically, the transition metal will be capable of binding to healthy proteins, for example proteins present in the blood, but will have a lower binding affinity, or will not bind, to these proteins following an ischemic event. For example, the transition metal may be capable of binding to healthy albumin, but will have a lower binding affinity, or will not bind, to albumin which has been modified following an ischemic event. However, the present invention is not bound by this theory. Examples of suitable transition metal salts include manganese, iron, cobalt, copper, and nickel salts. Cobalt (II) salts are preferred.

The salt is typically one which dissociates in water to give the transition metal ion and the anion. Any anion which provides a salt which is soluble in water and dissociates on dissolution can therefore be used. Examples of suitable salts for use in the invention include halides, for example, chlorides. A preferred salt is cobalt (II) chloride.

Since this test is titrimetric, the amount of transition metal salt available for reaction with the sample must be known. The method of the present invention, which enables accurate determination of the amount of an electroactive substance present in a cell, is therefore particularly useful in this context.

The preferred amount of transition metal salt present in the electroactive substance depends on the nature of the salt and the sample to be tested, as well as the volume of sample the substance is to be contacted with. Typically, where the transition metal is cobalt (II), the cobalt (II) salt is present in an amount such that when mixed with a sample to be tested (e.g. when a dried electroactive substance is re-suspended in a sample), the cobalt(II) concentration in the resulting mixture is from 0.1 to 100 mmoldm⁻³. Where the sample to be tested is plasma, the cobalt (II) salt is preferably present in an amount such that when mixed with a sample to be tested, the cobalt(II) concentration in the resulting mixture is from 1 to 20, preferably from 4.25 to 5.25 mmoldm⁻³. The most preferred concentration of cobalt (II) salt in the mixture is from 4.5 to 5.0, for example about 4.75 mmoldm⁻³. These concentrations may be achieved, for example, using an electroactive substance comprising more than 5.5 mmoldm⁻³ (for example 30 to 40 mmoldm⁻³) cobalt (II) salt, and subsequently diluting the electroactive substance with a known volume of the sample itself (for example using an electroactive substance: sample ratio of 1:1 to 1:20, e.g. 1:5 to 1:10). For example, 0.2 μl of an electroactive substance having a concentration of 35.6 mmoldm⁻³ cobalt (II) salt may be dried into or onto the device of the invention, and subsequently re-suspended in 1.5 μl of sample, providing a concentration of approximately 4.75 mmoldm⁻³ in the resulting mixture.

The electroactive substance preferably also comprises an electrode area normalising agent having a current which is dependent on electrode area. Typically, the electrode area normalising agent has a current which is not dependent on whether or not the sample is ischemic. The electrochemical measurement of the current produced by the transition metal salt is dependant on the surface area of the electrode used for the measurement. Therefore, in order to obtain a more precise measurement of the current generated by the transition metal, it is desirable to normalise the measured value using an electrode area normalising agent. It is not essential, although it is preferred, that the electrode area normalising agent fully and precisely normalises the measured current for electrode area. The normalising agent should, however, provide some degree of correction to account for variation in the electrode area. In the context of the present invention, ‘normalise’ therefore means to provide some degree of correction.

Normalising for electrode area can be done by measuring the current produced by the electrochemical reaction of the electrode area normalising agent substantially simultaneously with the measurement of the transition metal current. The same electrode is used for both measurements. The current measured due to oxidation/reduction of the transition metal can then be normalised using the measurement obtained for the electrode area normalising agent, by any suitable technique.

For example, a more accurate result can be obtained using the value I_{TM}/I_{NA} wherein I_{TM} is the current obtained due to oxidation/reduction of the transition metal and I_{NA} is the current obtained due to oxidation/reduction of the electrode area normalising agent. By using this normalised value for the transition metal current, errors in the measured result due to changes in electrode area can be minimised.

The electrode area normalising agent has a reduction/oxidation potential different from the transition metal. Further, it typically does not bind, or binds only weakly, to proteins, for example proteins in the blood including albumin. The electrode area normalising agent may, for example, form only an outer sphere complex with the protein. The electrode area normalising agent typically contains a heavy metal such as ruthenium or osmium. Examples of suitable electrode area normalising agents therefore include ruthenium or osmium complexes, for example complexes with amine-based ligands. Preferred electrode area normalising agents include ruthenium and osmium hexaamine chlorides, in particular ruthenium hexaamine chloride.

Typically, the electrode area normalising agent is present in an amount such that when mixed with a sample to be tested (e.g. when a dried electroactive substance is re-suspended in a sample), the electrode area normalising agent concentration in the resulting mixture is from 0.1 to 100 mmoldm⁻³, preferably from 1 to 10 mmoldm⁻³, more preferably from 3 to 3.5 or about 3.2 mmoldm⁻³. These concentrations may be achieved, for example, using an electroactive substance comprising greater than 5 mmoldm⁻³ (for example 20 to 30 mmoldm⁻³) and subsequently diluting the electroactive substance with a known volume of the sample itself (for example using a electroactive substance: sample ratio of 1:1 to 1:20, e.g. 1:5 to 1:10). For example, 0.2 μl of an electroactive substance having a concentration of 24 mmoldm⁻³ electrode area normalising agent may be dried into or onto the device of the invention, and subsequently re-suspended in 1.5 μl of sample, providing a concentration of approximately 3.2 mmoldm⁻³ in the resulting mixture.

The electroactive substance of this embodiment of the invention typically comprises a chloride or sulfate salt, such as those exemplified above. Potassium or sodium chloride or sulfate are preferred. The salt is typically present in an amount such that when mixed with a sample to be tested, the salt concentration in the resulting mixture is from 1 to 300 mmoldm⁻³ preferably from 6 to 60 mmoldm⁻³, more preferably from 10 to 30 mmoldm⁻³.

The electroactive substance typically also comprises a wetting agent, for example polyvinylpyrolidone (PVP). PVP is typically present in an amount such that when the electroactive substance is mixed with a sample to be tested, the PVP concentration in the resulting mixture is from 0.01 to 30% w/v, for example 0.2 to 5% w/v, preferably 0.7% w/v. The electroactive substance itself may have a higher concentration of PVP which is then diluted with a known volume of sample to provide the required concentration. If the concentration of polyvinylpyrolidone is too high, resuspension occurs slowly. Thus, typically no more than 5% w/v, preferably no more than 2% w/v or 1.5% w/v, more preferably no more than 1% w/v, polyvinylpyrrolidine is present. However, if the concentration of polyvinylpyrolidone is too low, insufficient wetting properties are provided.

The polyvinylpyrolidone typically has an average molecular weight of up to 100,000. Preferred average molecular weights are at least 5000, more preferably at least 7,500. Further, the molecular weight is preferably no more than 50,000, more preferably no more than 20,000, for example no more than 15,000 or no more than 12,500. A preferred average molecular weight is about 10,000. Use of polyvinylpyrolidone having such a molecular weight has been found to lead to faster re-suspension of the electroactive substance.

Electrochemical measurements are preferably taken at a pH of from 6 to 8, for example from 6.5 to 7.5, preferably from 6.8 to 7.2. A buffer can be included in the electroactive substance to ensure that the pH of the electroactive substance once re-suspended in a sample to be tested remains substantially within the range 6 to 8. The buffer should be one that provides a pH of from 6 to 8 when the electroactive substance is suspended in water. Any buffer can be used which is not electrochemically active over the potential range of the measurement to be carried out. Suitable buffers will be known to those skilled in the art and an example of a buffer which can be used is (N-morpholino)propanesulphonic acid (MOPS). Preferred electroactive substances comprise a manganese, iron, cobalt, nickel or copper salt; a ruthenium or osmium complex; a wetting agent; optionally a chloride or sulfate salt; and optionally a buffer. Particularly preferred compositions comprise a cobalt salt, a ruthenium or osmium complex; polyvinylpyrolidone; optionally a chloride or sulfate salt; and optionally a buffer. In a preferred embodiment a buffer is present in these compositions. Further details regarding electroactive substances can be found in GB application no. 0414551.2 and the international application claiming priority therefrom (filed on the same day as the present application and entitled ELECTROCHEMICAL SENSOR), the contents of which are incorporated herein by reference.

The present invention also provides a device which can be used in the above described titrimetric electrochemical test. The device comprises an electrochemical cell in the form of a receptacle, for example, an electrochemical cell as described above. Optionally, the device of the invention may comprise two or more electrochemical cells. The electroactive substance of the device of the invention comprises a transition metal salt and preferred electroactive substances are those described above.

### EXAMPLES

### Example 1

A device of the type depicted in FIG. 2, wherein the working electrode is a carbon electrode and the pseudo reference electrode is a Ag/AgCl electrode, was used to carry out electrochemical tests. The volume of the receptacle defined by the walls, adhesive and bottom surface of the membrane was 1.5 ul. 0.2 ul of a reagent mixture comprising 35.6 mM CoCl₂, 24 mM Ru Hexaamine Chloride and 150 mM KCl in 5% w/v PVP and MOPS buffer (providing a pH of 7.0) was inserted into the receptacle of the device and dried, prior to attachment of a membrane over the device. The membrane used was a Whatman VF2 membrane.

Normal plasma was applied to the electrochemical cell, with 1.5 ul filling the well volume, and the reagent mixture allowed to re-suspend in the plasma. The final resuspended concentration of Co in the 1.5 ul plasma volume was 4.75 mM and the corresponding concentration of Ru was 3.2 mM.

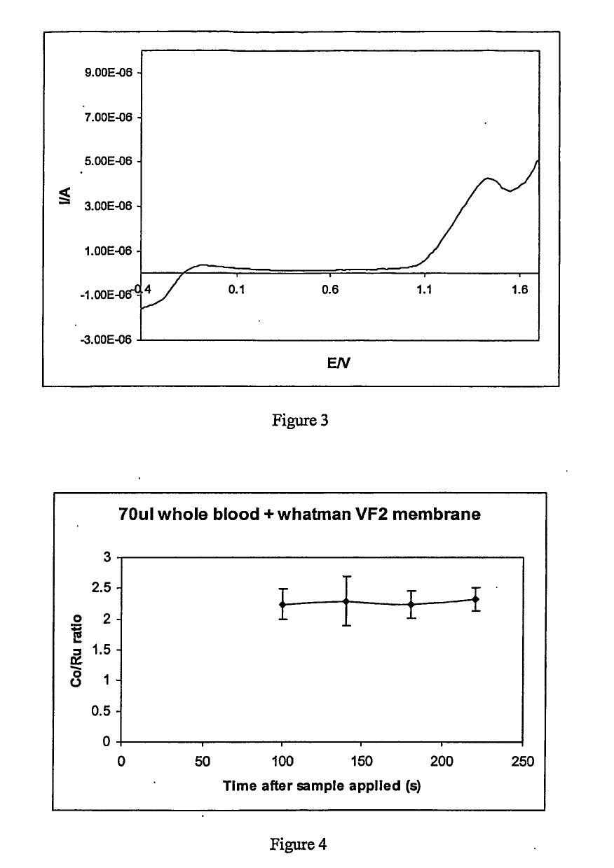

A time varying potential was applied to the cell, the applied potential being decreased to −0.4V and then increased to 1.7V. The current was measured during the potential scan and the results are depicted in FIG. 3.

### Example 2

The method of Example 1 was repeated, except that 70 ul of whole blood was applied to the device, with the Whatman VF2 membrane allowing plasma to pass through into the receptacle. A volume of approx. 1.5 ul fills the volume of the cell. A wetting time of 100 seconds was allowed before applying the measuring potential.

The current was measured during the application of the measuring potential as for Example 1 and the ratio of I(Co):I(Ru) was also calculated in order to normalise the measured cobalt oxidation current for electrode area. Similar measurements of the ratio of I(Co):I(Ru) were taken at 140, 180 and 220 seconds after addition of the plasma sample and the results are depicted in FIG. 4. This Figure shows the ratio I(Co):I(Ru) on the y-axis and the time after addition of the plasma sample on the x-axis. As this Example demonstrates, a substantially constant current is achieved over the period of measurement, indicating that the concentration of reagents within the volume of the receptacle is substantially constant during this period.

The invention has been described with reference various specific embodiments and examples. It is to be understood that the invention is not limited to the specific embodiments and examples described.

1. A method of confining an electroactive substance within an electrochemical cell in the form of a receptacle, said method comprising
(a) providing an electrochemical cell in the form of a receptacle, the receptacle having a first open part to allow entry of a sample into the receptacle, and a second open part to allow escape of air displaced by the entering sample, the electrochemical cell having a working electrode and a counter electrode;
(b) providing an electroactive substance, which substance is contained within the receptacle;
(c) providing a permeable or semi-permeable membrane, comprising one or more layers, covering the first open part of the receptacle; and
(d) inserting the sample into the receptacle through the membrane, such that (1) the electroactive substance and (2) the sample, are in contact with each other and with said working electrode;
wherein the electroactive substance is confined within the receptacle during step (d).

2. A method of electrochemically testing a sample according to claim 1, which method further comprises
(i) applying a potential across the electrochemical cell; and
(ii) measuring the resulting electrochemical response;
wherein the electroactive substance is confined within the receptacle during steps (i) and (ii).

3. A method according to claim 2, wherein the electroactive substance comprises a transition metal salt.

4. A method according to claim 3, wherein the transition metal salt is a cobalt (II) salt.

5. A method according to claim 3, wherein step (ii) comprises measuring the current generated by electrochemical reaction of the transition metal salt.

6. A method according to claim 3, wherein the electroactive substance additionally comprises one or more components selected from
an electrode area normalizing agent having a current which is dependent on electrode area;
a chloride or sulfate salt; and
a wetting agent.

7. A method according to claim 1, wherein the membrane is impermeable to red blood cells and the sample is plasma or serum.

8. A method according to claim 1, wherein the electroactive substance is in dried form and wherein step (d) comprises suspending at least a part of the electroactive substance in the sample.

9. Use of a membrane comprising one or more layers to confine an electroactive substance within a receptacle following insertion into the receptacle of a liquid sample,
wherein the receptacle comprises a first open part, and is in the form of an electrochemical cell,
wherein the membrane is permeable to the sample, and is located such that it covers the first open part of the receptacle, and
wherein the electroactive substance is contained within the receptacle prior to insertion of the sample.

10. Use according to claim 9, wherein the electroactive substance is as defined in claim 3.

11. Use according to claim 9, wherein the membrane is impermeable to red blood cells and the sample is plasma or serum.

12. A device comprising
an electrochemical cell in the form of a receptacle, the receptacle having a first open part to allow entry of a sample into the receptacle, and a second open part to allow escape of air displaced by the entering sample, wherein the electrochemical cell has a working electrode and a counter electrode;
an electroactive substance as defined in any one of claims 3, 4, 6 or 7, the substance being contained in the receptacle;
a permeable or semi-permeable membrane, comprising one or more layers, positioned such that it covers the first open part of the receptacle;
means for applying a voltage across the cell; and
means for measuring the resulting electrochemical response across the cell.

13. A device according to claim 12, wherein the working electrode has at least one dimension of less than 50 μm.

14. A device according to claim 12, wherein the electroactive substance is in dried form.

15. (canceled)
